(19) United States
(12) Patent Application Publication
(10) Pub. No.: US 2019/0152159 A1
(43) Pub. Date: May 23, 2019

(54) Upconversion In Fiber Or Dummy Part For Simultaneous Laser Plastics Welding

(71) Applicant: Branson Ultrasonics Corporation, Danbury, CT (US)

(72) Inventor: Scott CALDWELL, New Milford, CT (US)

(73) Assignee: Branson Ultrasonics Corporation, Danbury, CT (US)

(21) Appl. No.: 16/183,203

(22) Filed: Nov. 7, 2018

Related U.S. Application Data
(60) Provisional application No. 62/587,548, filed on Nov. 17, 2017.

(51) Int. Cl. B29C 65/16; B29C 65/00

(52) U.S. Cl. CPC B29C 65/1667; B29C 65/1612; B29C 66/73921; B29C 65/1635; B29C 65/1687

(57) ABSTRACT

Sensors incorporated within a laser channel detect laser light upconverted by a dopant. The dopant is located after a delivery end of a laser delivery optical fiber and upconverts laser light that has traveled from a laser light source from a laser bank through one of a plurality of laser channels through to a location after the delivery end of a laser delivery optical fiber. In some embodiments, the dopant is positioned at the delivery end of the laser delivery optical fiber. In other embodiments, the dopant is positioned within a dummy part or on a surface of at least a work piece.

### CROSS-REFERENCE TO RELATED APPLICATIONS

This application claims the benefit of U.S. Provisional Application No. 62/587,548 filed on Nov. 17, 2017. The entire disclosure of the above application is incorporated herein by reference.

### FIELD

The present disclosure relates to plastics welding and, more particularly, relates to assessing optical fibers in direct delivery welding and simultaneous laser welding applications.

### BACKGROUND

This section provides background information related to the present disclosure which is not necessarily prior art.

Laser welding is commonly used to join plastic or resinous parts, such as thermoplastic parts, at a welding zone.

There are many different laser welding technologies. One useful technology is simultaneous through transmissive infrared welding, referred to herein as STTIr. In STTIr, the full weld path or area (referred to herein as the weld path) is simultaneously exposed to laser radiation, such as through a coordinated alignment of a plurality of laser light sources, such as laser diodes.

An example of STTIr is described in U.S. Pat. No 6,528,755 for “Laser Light Guide for Laser Welding,” the entire disclosure of which is incorporated herein by reference. In STTIr, the laser radiation is typically transmitted from one or more laser sources to the parts being welded through one or more optical waveguides which conform to the contours of the parts' surfaces being joined along the weld path.

FIG. 1 shows an example of a prior art STTIr laser welding system 100. STTIr laser welding system includes a laser support unit 102 including one or more controllers 104, an interface 110, one or more power supplies 106, and one or more chillers 108. The STTIr laser welding system may also include an actuator, one or more laser banks 112, and an upper tool/waveguide assembly 35 and a lower tool 25 fixtured on a support table. Each laser bank 112 includes one or more laser channels 113 with each laser channel having a laser light source 122. Laser support unit 102 is coupled to the actuator and each laser bank 112 and provides power and cooling via power supply (or supplies) 106 and chiller (or chillers) 108 to laser bank(s) 112 and controls the actuator and laser bank(s) 112 via controller 104. The actuator is coupled to either the upper tool/waveguide assembly and/or to the lower tool and moves them towards each other under control of controller 104. In operation, laser bank 112 directs laser energy from a source of laser radiation (such as the laser light source 122 of each laser channel 113) through a plurality of laser delivery bundles 10. Each laser delivery bundle 10 may be further split into legs and each leg is comprised of at least a laser delivery optical fiber. If laser delivery bundle 10 is not split into legs, then each laser delivery bundle 10 is comprised of at least a laser delivery optical fiber. Each laser delivery optical fiber delivers laser energy from the source of laser radiation (such as laser light source 122 of laser channel 113) of laser bank 112 through a waveguide 30 to a plurality of work pieces 60 to be welded together. Waveguide 30 homogenizes the laser energy delivered to work pieces 60 through each laser delivery optical fiber.

To ensure an accurate and comprehensive weld, the gap between any waveguide and the workpiece closest to the waveguide is kept as small as possible. Correspondingly, to improve efficiency, the gap between the delivery end of the fiber bundle and the waveguide is also kept as small as possible. It is desirable to monitor the degradation of optical fibers over multiple weld cycles while keeping the aforementioned gaps as small as possible.

### SUMMARY

This section provides a general summary of the disclosure, and is not a comprehensive disclosure of its full scope or all of its features.

In an aspect of the present disclosure, a method for determining intensity of laser light delivered by a laser delivery bundle of a simultaneous welding system is provided. The method includes directing laser light from a laser light source of each laser channel of a laser bank of the simultaneous welding system to each laser delivery optical fiber of the laser delivery bundle coupled to that laser channel. The laser light is received by a dopant that is positioned to receive the laser light at a delivery end of each laser delivery optical fiber, and the dopant upconverts the laser light. The upconverted laser light passes back through that laser delivery optical fiber to a sensor positioned within the laser channel to sense the upconverted laser light. The sensor senses an intensity of the upconverted laser light and outputs a signal indicative of the sensed intensity of the upconverted laser light to a controller. The controller determines the intensity of laser light delivered by the laser delivery bundle based on the sensed signal indicative of the upconverted laser light.

According to an aspect, positioning the dopant further includes positioning a dopant end at a location downstream of the delivery end of each laser delivery optical fiber.

According to an aspect, positioning the dopant further includes positioning a dopant end on the delivery end of each laser delivery optical fiber.

According to an aspect, positioning the dopant includes positioning a dummy part infused with the dopant, wherein the dummy part is positioned where a plurality of work pieces would reside during a weld cycle.

According to an aspect, directing the laser light includes directing the laser light through the laser delivery optical fiber to a waveguide and through the waveguide to a plurality of work pieces where a surface of one of the work pieces is covered with a paint or lacquer comprised of the dopant.

According to an aspect, the sensor is includes a chromatic bandpass filter.

According to an aspect, the controller alerts a user when the controller determines that the intensity of light delivered by the laser delivery bundle is unsatisfactory.

According to an aspect, the controller adjusts the laser light intensity when the controller determines that the intensity of laser light delivered by the laser delivery bundle is unsatisfactory.

In another aspect of the present disclosure, a simultaneous laser welding system includes a laser bank having one or more laser channels with each laser channel including a laser light source. The laser light from the laser light source of each laser channel is directed through a laser delivery bundle through a waveguide to a plurality of work pieces. Each laser delivery bundle includes at least a laser delivery optical fiber. A dopant is positioned at a location downstream of the delivery end of each laser delivery optical fiber for upconverting laser light back through the laser delivery optical fiber. At least a sensor positioned within each laser channel senses upconverted laser light from the dopant and outputs a signal indicative of the sensed upconverted laser light to a controller. The controller is configured to determine the intensity of laser light delivered by the laser delivery bundle based on the intensity of the sensed upconverted laser light.

According to an aspect, each laser delivery optical fiber has a dopant comprising a dopant end positioned at a location downstream of the delivery end of the corresponding laser delivery optical fiber.

According to an aspect, the dopant comprises a dopant end positioned on a delivery end of each laser delivery optical fiber.

According to an aspect, the dopant includes a dummy part infused with the dopant and is positioned where a plurality of work pieces would reside during a weld cycle.

According to an aspect, the dopant includes a paint or lacquer applied to a surface of one of the work pieces.

According to an aspect, the controller is configured to alert a user when the controller determines the intensity of laser light delivered by the laser delivery bundle.

According to an aspect, the controller is configured to adjust the laser light intensity when the controller determines that the intensity of laser light delivered by the laser delivery bundle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustrating a prior art laser welding system;

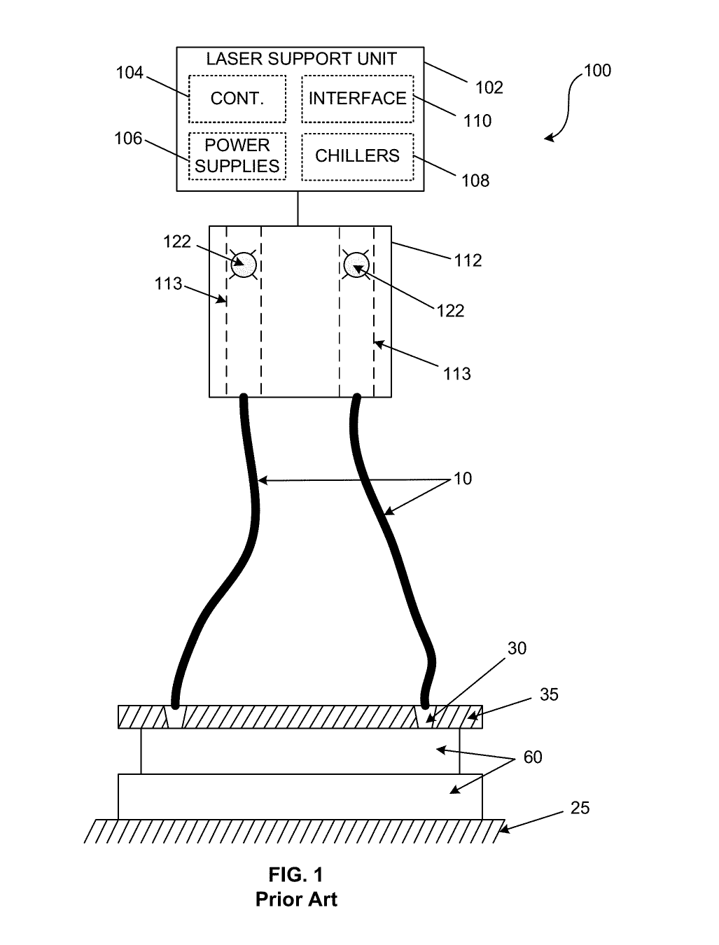

FIG. 2 is a schematic view illustrating an embodiment according to the present disclosure;

FIG. 3 is a schematic view illustrating an embodiment according to the present disclosure;

FIG. 4 is an enlarged schematic view illustrating a laser channel according to an embodiment of the present disclosure;

FIG. 5 is an enlarged schematic view illustrating another laser channel according to an embodiment of the present disclosure;

FIG. 6 is a schematic view illustrating another embodiment according to the present disclosure;

FIG. 7 is a flow chart of control logic for a control routine for determining whether a laser delivery bundle is delivering satisfactory laser light intensity according to an embodiment of the present disclosure; and

FIG. 8 is a flow chart of control logic for a control routine for determining whether a laser delivery bundle is delivering satisfactory laser light intensity according to another embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

As used herein, the term “composition” refers broadly to a substance containing at least the preferred metal elements or compounds, but which optionally comprises additional substances or compounds, including additives and impurities. The term “material” also broadly refers to matter containing the preferred compounds or composition.

In addition, disclosure of ranges includes disclosure of all values and further divided ranges within the entire range, including endpoints and sub-ranges given for the ranges.

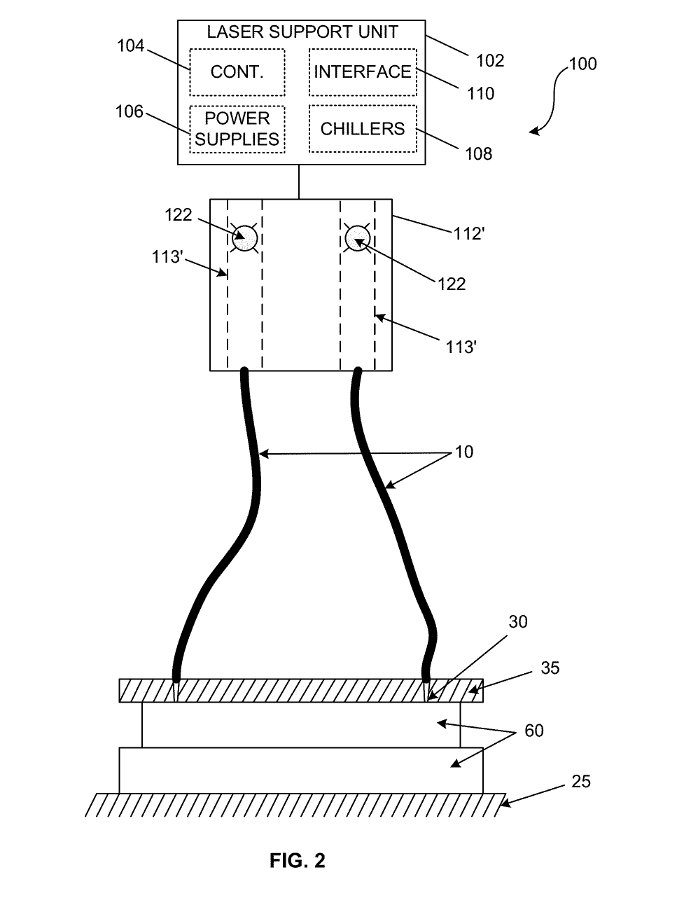

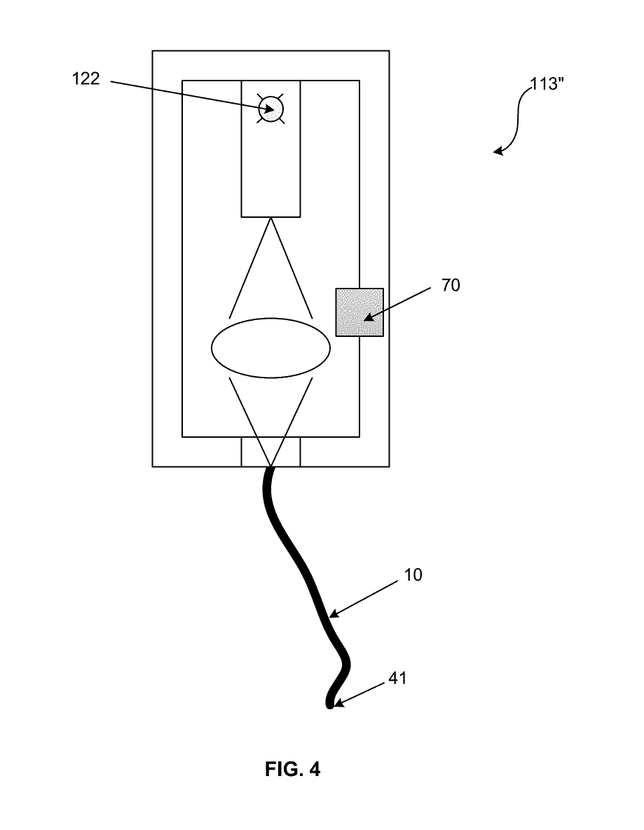

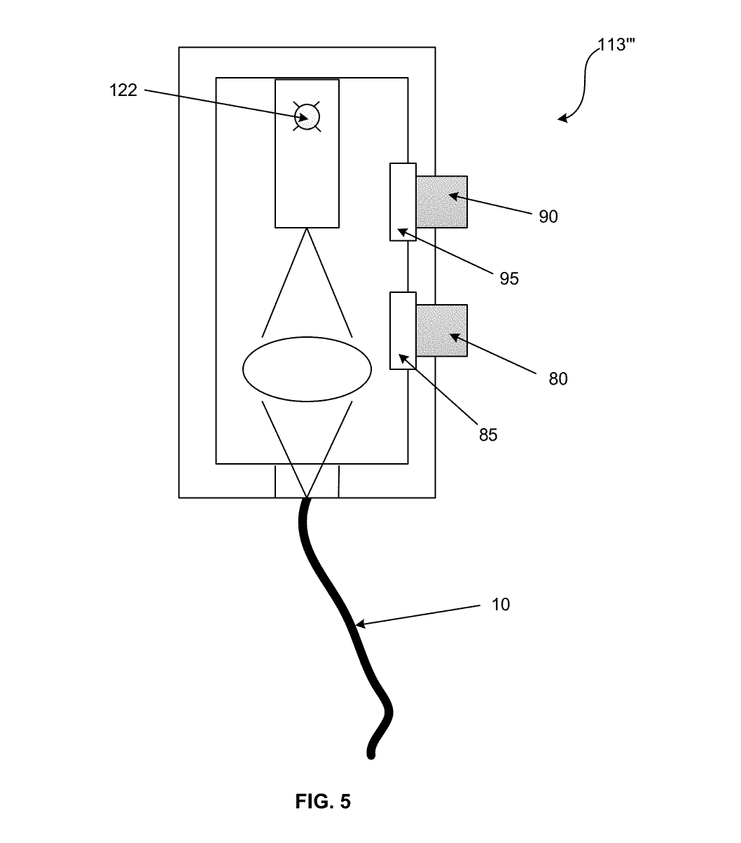

Under many aspects, the embodiments described according to the present disclosure may be used as part of an STTIr laser welding system, such as STTIr laser welding system 100 shown in FIG. 2. In such aspects, laser welding system 100 includes laser bank 112′ with at least one laser channel 113′, wherein laser channel 113′ includes at least a sensor or a plurality of sensors (such as sensor 70 (FIG. 4) or upconverted laser light sensor 80 (FIG. 5) and laser channel sensor 90 (FIG. 5), as described in more detail below) for sensing upconverted laser light from a dopant (as described more fully below). Laser support unit 102 is in communication with the one or more associated sensors (such as sensor 70, upconverted laser light sensor 80, and laser channel sensor 90).

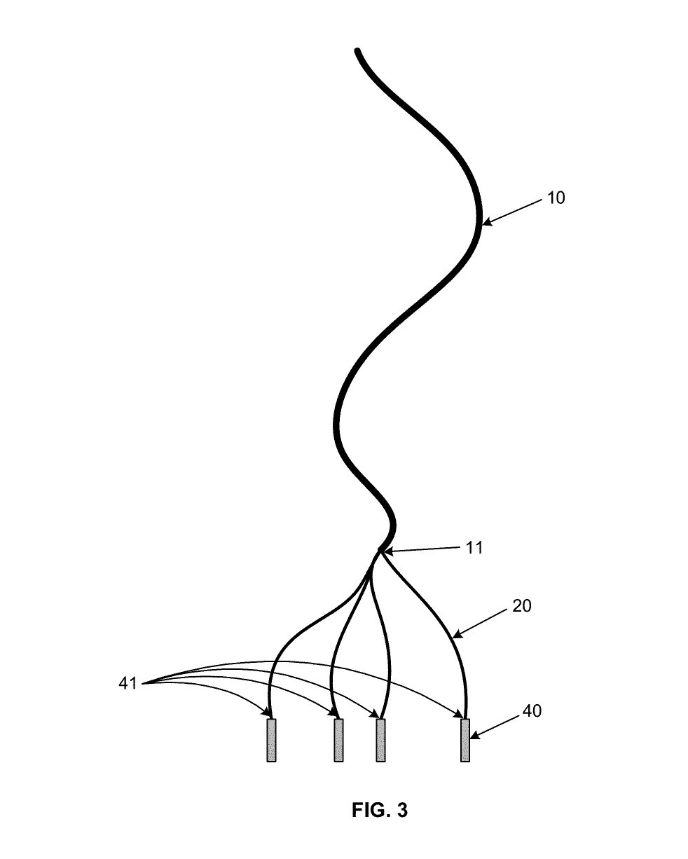

Turning now to FIG. 3, according to an embodiment of the present disclosure, a dopant end 40 at a delivery end 41 (i.e., the end of the laser delivery optical fiber where laser energy is directed to plurality of work pieces 60 to be welded) of a leg 20 of laser delivery bundle 10 has a dopant that upconverts the laser light from laser light source 122 (FIGS. 4 and 5) to light having a shorter wavelength that is emitted by the dopant. Under some embodiments, a preexisting laser delivery bundle 10 with legs 20 is modified by the addition of dopant end 40 to the delivery end 41 of at least one of legs 20.

Appropriate dopants include upconverting nanoparticles, such as lanthanide-doped nanoparticles and semiconductor nanoparticles (also known as quantum dots). Lanthanide-doped nanoparticles include yttrium, erbium, gadolinium, calcium, and thulium, as well as fluorides and oxides thereof. Applicable semiconductor nanoparticles include CdSe, PbS, and PbSe. Notably, the upconverting nanoparticles should be selected with a view towards upconverting wavelengths used in laser welding. Therefore, in some aspects, particularly suitable upconverting nanoparticles include erbium and semiconductor nanoparticles, which upconvert wavelengths at about 980 nm to about 550 nm. The dopants may be located on a terminal section of a delivery end 11 (FIG. 3) of a laser delivery bundle 10 (e.g., on a terminal section of the delivery end 41 of one of legs 20 of a laser delivery bundle), may be painted on a plurality of work pieces to be welded, or may be incorporated within dummy parts. In each aspect, the dopants are positioned so that upconverted laser light passes upstream through a delivery end of an associated laser delivery optical fiber to an associated sensor located within the applicable laser channel 113′ in laser bank 112′.

In many embodiments, the dopants are integrated into an article, such as dopant end 40 or a dummy part (as described in greater detail below). Under some embodiments, the article has a glass or crystal structure with the dopants infused therein. In yet other embodiments, the dopant article is painted or covered with some lacquer, where the paint or lacquer is comprised of the dopant.

Referring again to FIG. 3 and now also to FIG. 4, an embodiment of laser channel 113′ is shown as laser channel 113″. Upconverted light from each dopant end 40 of each associated leg 20 passes through each associated leg 20 from delivery end 41 of each leg 20 and is transmitted upstream through laser delivery bundle 10 to sensor 70. Sensor 70 is positioned within laser channel 113″ to sense intensity of upconverted laser light from each dopant end 40 that has been transmitted through leg 20 to laser delivery bundle 10 to sensor 70 from delivery end 41 of each leg 20. Sensor 70 is exposed to not only such light upconverted by each dopant end 40 but also to laser light emitted from laser light source 122. Thus, to ensure sensor 70 accurately senses intensity of upconverted laser light from each dopant end 40, the sensor 70 should not sense laser light at the wavelength emitted by laser light source 122. Where laser channel 113″ is used in connection with a laser delivery bundle 10 having multiple legs 20, sensor 70 senses the total light passing through laser delivery bundle 10. Therefore, where each leg 20 has a dopant end 40, the number of inoperative legs 20 is directly related to the percentage of light intensity expected to be sensed by sensor 70. As an example, if there are four legs 20 per a laser delivery bundle 10 with associated laser channel 113″, and sensor 70 is determined to have sensed 75% of the light expected to have been sensed if every leg 20 was fully operational, the cause may be that one of legs 20 is fully inoperative. If, on the other hand, it is determined there is not a directly proportional (e.g., where a 13% reduction is sensed when there are 4 legs 20) reduction in light intensity sensed in comparison to the number of legs 20, the cause may be that one or more legs 20 are operating somewhat but not fully.

Referring again to FIG. 3 and now also to FIG. 5, another embodiment of laser channel 113′ is shown as laser channel 113′″. Upconverted light from each dopant end 40 of each associated leg 20 passes through each associated leg 20 from delivery end 41 of each leg 20 and is transmitted upstream through laser delivery bundle 10 to upconverted laser light sensor 80. Upconverted light sensor 80 is illustratively positioned within laser channel 113′″ to sense intensity of upconverted laser light from each dopant end 40 that has been transmitted through each leg 20 to upconverted laser light sensor 80 from delivery end 41 of each leg 20. A laser channel sensor 90, on the other hand, senses intensity of laser light emitted from laser light source 122. In such an embodiment, the upconverted laser light from each dopant end 40 is sensed by upconverted laser light sensor 80 but not by laser channel sensor 90. Similarly, laser light emitted from laser light source 122 is not sensed by upconverted laser light sensor 80 but is sensed by laser channel sensor 90. In some embodiments, chromatic band pass filters are used to filter the light passing to the upconverted laser light sensor 80 and laser channel sensor 90 so that only light having the wavelength of the upconverted laser light is passed to upconverted laser light sensor 80 and only light having the wavelength of laser light emitted by laser light source 122 is passed to laser bank channel 90. In this regard, a first chromatic bandpass filter 85 may be integrated with or cover upconverted laser light sensor 80 to prevent upconverted laser light sensor 80 from sensing laser light emitted by laser light source 122, and a second chromatic bandpass filter 95 may be integrated with or cover laser channel sensor 90 to prevent laser channel sensor 90 from sensing light emitted by upconverted laser light from each dopant end 40. Intensity of upconverted laser light from each dopant end 40 is directly proportional to intensity of light emitted by laser light source 122. Therefore, the throughput of an associated laser bundle 10 may be determined by comparing the intensity of light sensed by laser channel sensor 90 with intensity of light sensed by upconverted laser light sensor 80. In some embodiments it is therefore contemplated that a signal indicative of the light intensity sensed by laser channel sensor 90 is output to controller 104 and a signal indicative of the light intensity sensed by upconverted laser light sensor 80 is output to controller 104, and that controller 104 compares the intensities to determine the throughput of an associated laser delivery bundle 10. Where laser channel 113′″ is used in connection with a laser delivery bundle 10 having multiple legs 20, upconverted laser light sensor 80 senses the total light passing through laser delivery bundle 10 where each leg 20 has a dopant end 40, the number of inoperative legs 20 is directly related to the percentage of light intensity expected to be sensed by upconverted laser light sensor 80. As an example, if there are four legs 20 per a laser delivery bundle 10 with associated laser channel 113′″, and upconverted laser light sensor 80 is determined to have sensed 75% of the light expected to have been sensed if every leg 20 was fully operational, the cause may be that one of legs 20 is fully inoperative. If, on the other hand, it is determined there is not a directly proportional (e.g., where a 13% reduction is sensed when there are 4 legs 20) reduction in light intensity sensed, the cause may be that one or more legs 20 are operating somewhat but not fully.

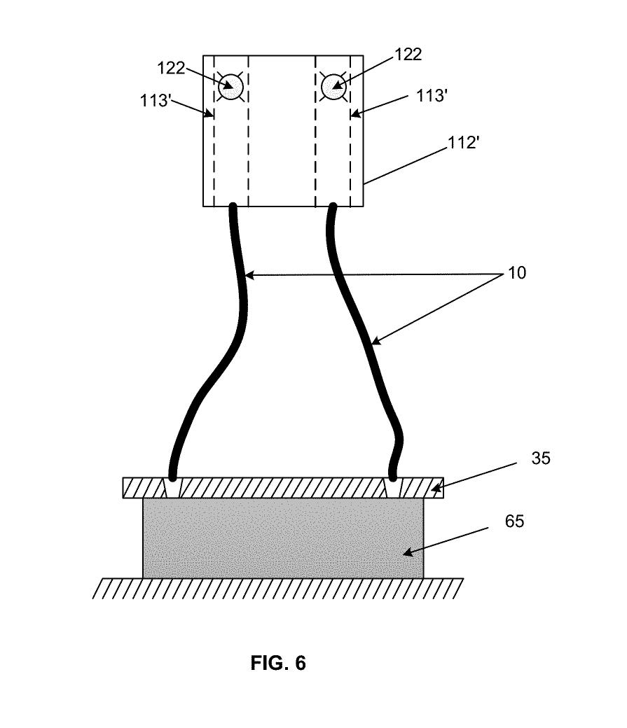

Referring to FIG. 6, an alternate embodiment is disclosed. Like in FIG. 2, this alternate embodiment includes laser bank 112′ having laser channel 113′. Each laser delivery bundle 10 may be further split into legs 20 and each leg 20 is comprised of at least a laser delivery optical fiber. If laser delivery bundle 10 is not split into legs, then each laser delivery bundle 10 is comprised of at least a laser delivery optical fiber. Each laser delivery optical fiber delivers laser energy from laser channel 113′ via laser light source 122 through a waveguide 30 to a plurality of work pieces 60 to be welded together. Waveguide 30 homogenizes the laser energy delivered to work pieces 60 through each laser delivery optical fiber. Between a number of weld cycles, a dummy part 65 is placed in the area where the plurality of work pieces 60 to be welded would reside during a weld cycle. Dummy part 65 upconverts laser light emitted by laser light source 122. Dummy part 65 may be sized to about the same cumulative size of the plurality of work pieces 60. According to several embodiments, dummy part 65 is a glass, plastic or crystal structure with the dopant infused therein. According to yet other embodiments, dummy part 65 is painted or lacquered with a coating comprised of the dopant. Upon placing dummy part 65 in the area where the plurality of work pieces 60 to be welded would reside during a weld cycle, laser light is delivered via laser light source 122 through laser delivery bundle 10 to waveguide 30 to dummy part 65. Because no weld is occurring, laser light source 122 need not be fired at an intensity that would otherwise be sufficient to weld (e.g., laser light source 122 may be fired at a lower intensity). At least a portion of the laser energy is upconverted and emitted by dummy part 65. The upconverted laser light emitted travels through waveguide 30 and laser delivery bundle 10 to sensor 70 (such as shown in FIG. 4). Sensor 70 senses the intensity of the upconverted laser light emitted by dummy part 65 and outputs a signal indicative of the sensed intensity to controller 104. The resulting intensity of light sensed by sensor 70 can then be compared to the initial intensity by controller 104 to determine whether the associated laser delivery bundle 10 is yet satisfactorily delivering light energy through it.

In even further embodiments, a surface of at least one of the plurality of work pieces 60 may be painted or lacquered with a coating comprised of the dopant. In this manner, during a weld cycle, laser energy delivered via laser light source 122 through laser delivery bundle 10 to waveguide 30 is upconverted in part by the paint or lacquer on the surface of the one of the plurality of work pieces 60. Such upconverted laser light travels through waveguide 30 and an associated laser delivery bundle 10 to sensor 70, where the sensor 70 senses the intensity of the upconverted laser light emitted by the paint of lacquer and outputs a signal indicative of the sensed intensity to controller 104. The resulting intensity of light sensed by sensor 70 can then be compared to the initial intensity by controller 104 to determine whether the associated laser delivery optical fiber is yet satisfactorily delivering light energy through it.

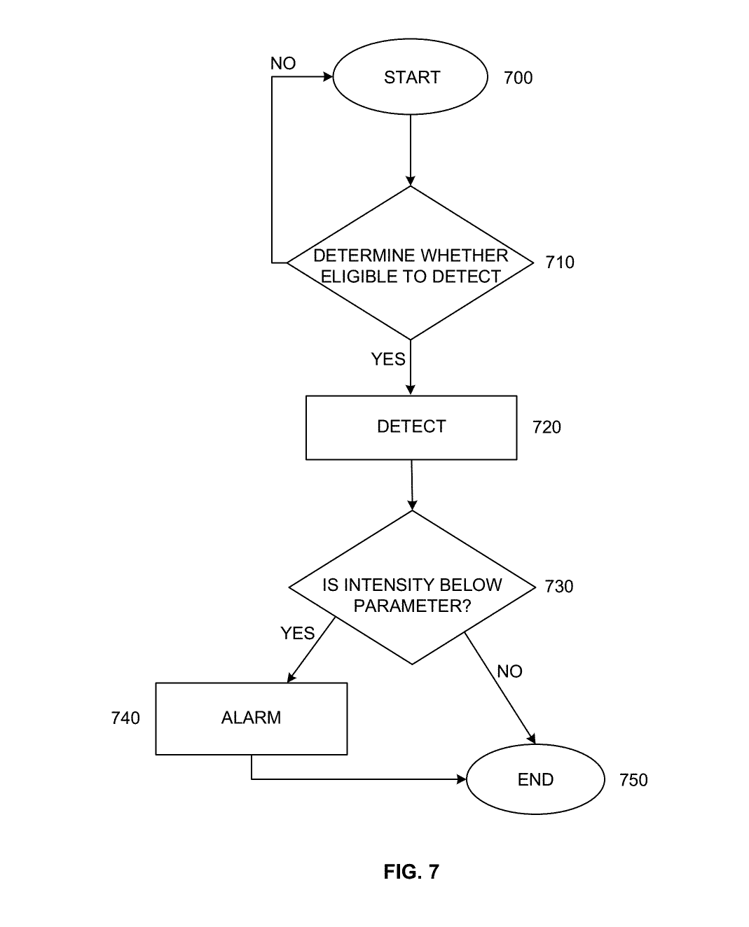

FIG. 7 is a flow chart of control logic for an example control routine implemented in controller 104 for determining whether a laser delivery bundle (such as laser delivery bundle 10) is delivering satisfactory laser light intensity. The control routine starts at 700 and proceeds to 710, where it determines whether determining whether the laser delivery bundle is delivering satisfactory laser light intensity is possible at that time. More specifically, if a dummy part (e.g., dummy part 65) is used to provide the dopant, the control routine first determines the dummy part 65 is in the position where the work pieces would reside during a weld cycle. After determining it is possible to determine whether a laser delivery bundle is delivering satisfactory laser light intensity, the control routine proceeds to 720, where a sensor (such as sensor 70 or upconverted laser light sensor 80) senses the emitted upconverted laser light. The control routine then proceeds to 730 where it determines whether the emitted upconverted laser light intensity sensed by the sensor is below a predetermined parameter. If the control routine determines that the sensed light intensity emitted as a result of upconversion is below the predetermined parameter, the control routine determines that the laser delivery bundle is not delivering satisfactory light intensity and proceeds to 740, where the control routine issues an alarm indicating same. After issuing the alarm or determining no alarm is required, the control routine proceeds to end at 750.

In further embodiments, the fiber feedback system further includes a closed control loop, as described in U.S. Pat. No. 7,343,218, which is commonly owned by the same assignee and is incorporated herein by reference.

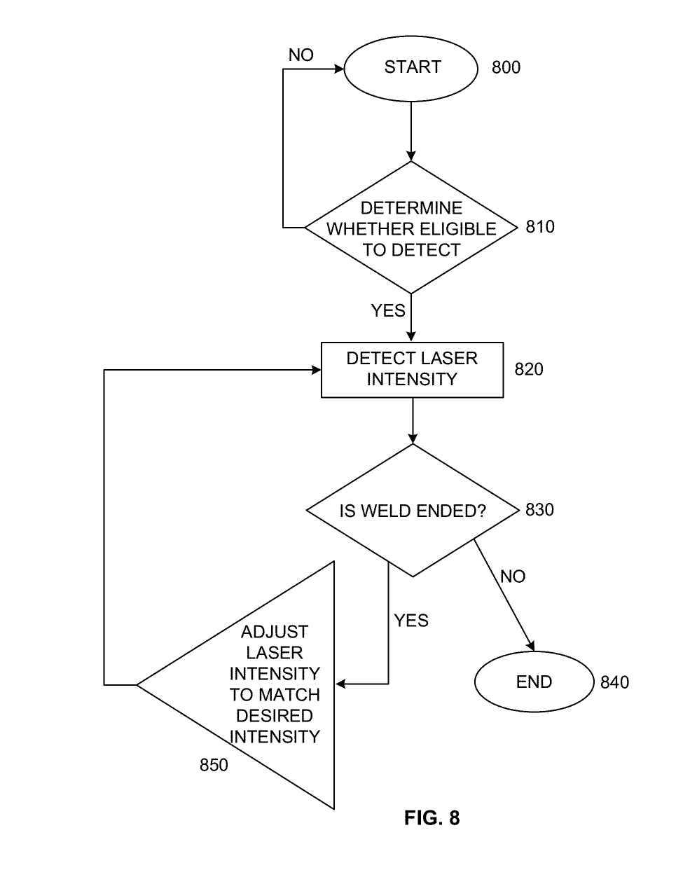

FIG. 8 is a flow chart of control logic for an example control routine implemented in controller 104 for determining whether a laser delivery bundle (such as laser delivery bundle 10) is delivering satisfactory laser light intensity. The control routine starts at 800 and proceeds to 810, where the it determines determines whether determining whether the laser delivery bundle is delivering satisfactory laser light intensity is possible at that time. More specifically, if a dummy part (e.g., dummy part 65) is used to provide the dopant, the control routine first determines the dummy part 65 is in the position where the work pieces would reside during a weld cycle. After determining it is possible to determine whether a laser delivery bundle is delivering satisfactory laser light intensity, the control routine proceeds to 820, where a sensor (such as sensor 70 or upconverted laser light sensor 80) senses the intensity of the emitted upconverted laser light. There is a direct correlation between the intensity of upconverted laser light sensed by the sensor and the intensity of laser light laser emitted by laser light source 122 of laser channel 113′ that is used in a weld cycle. The control routine proceeds to 830, where it assesses whether the sensed intensity of the upconverted laser light is below a predetermined parameter. If the intensity of the upconverted laser light is below the predetermined parameter, the control routine determines that the laser delivery bundle is not delivering satisfactory laser light intensity and proceeds to 840. At 840, the control routine proportionally adjusts the intensity of laser light being emitted by laser light source 122 of laser channel 113′ to bring the intensity of the sensed upconverted laser light within the predetermined parameter. Further, if the intensity of the upconverted laser light is sensed occurs during a welding cycle, and the control routine determines that the intensity of the sensed upconverted laser light is below a predetermined parameter, the control routine in some embodiments will rerun the weld cycle after adjusting the intensity of the laser light emitted by the associated laser light source 122 to bring the intensity of the sensed upconverted laser light within the predetermined parameter. After adjusting the intensity of the laser light emitted by the laser light source or determining no such adjustment is warranted, the control routine proceeds to 850 where it determines whether the weld routine is done. If the weld routine is not done, the control routine branches back to 820. If it is determined that the weld routine is done, the control routine proceeds to end at 860. If at 830 the control routine determines that the sensed intensity of the upconverted laser light is not below the predetermined parameter, the control routine branches to 850.

Controller 104 can be or includes any of a digital processor (DSP), microprocessor, microcontroller, or other programmable device which are programmed with software implementing the above described logic. It should be understood that alternatively it is or includes other logic devices, such as a Field Programmable Gate Array (FPGA), a complex programmable logic device (CPLD), or application specific integrated circuit (ASIC). When it is stated that controller 104 performs a function or is configured to perform a function, it should be understood that controller 104 is configured to do so with appropriate logic (such as in software, logic devices, or a combination thereof), such as control logic shown in the flow charts of FIGS. 7 and 8. When it is stated that controller 104 has logic for a function, it should be understood that such logic can include hardware, software, or a combination thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for determining intensity of laser light delivered by each laser delivery bundle in a simultaneous laser welding system, the method comprising:
directing laser light from a laser light source of each laser channel of a laser bank of the simultaneous laser welding system to each delivery optical fiber of the laser delivery bundle coupled to that laser channel;
receiving said laser light with a dopant positioned to receive said laser light at a delivery end of each laser delivery optical fiber and upconverting said laser light with the dopant and passing said upconverted laser light back through that laser delivery optical fiber to a sensor positioned within said laser channel to sense said upconverted laser light;
sensing the upconverted laser light with the sensor and outputting with the sensor to a controller a signal indicative of intensity of said sensed upconverted laser light; and
determining with said controller intensity of laser light delivered by the laser delivery bundle based on the intensity of said sensed upconverted laser light.

2. The method according to claim 1, wherein positioning the dopant comprises positioning a dopant end at a location downstream of the delivery end of each laser delivery optical fiber.

3. The method according to claim 1, wherein positioning the dopant comprises positioning a dopant end on the delivery end of each laser delivery optical fiber.

4. The method according to claim 1, wherein positioning the dopant comprises positioning a dummy part infused with said dopant, wherein said dummy part is positioned where a plurality of work pieces would typically reside during a weld cycle.

5. The method according to claim 1, directing said laser light further comprises directing said laser light through said laser delivery optical fiber to a waveguide and through the waveguide to a plurality of work pieces, wherein a surface of one of the work pieces is covered with a paint or lacquer comprised of the dopant.

6. The method according to claim 1, further comprising covering the sensor with a chromatic bandpass filter.

7. The method according to claim 1, further comprising alerting via the controller a user when said controller determines that the intensity of laser light delivered by the laser delivery bundle is unsatisfactory.

8. The method according to claim 1, further comprising adjusting via the controller the laser light intensity when the controller determines that the intensity of laser light delivered by the laser delivery optical fiber is unsatisfactory.

9. A simultaneous laser welding system, the simultaneous laser welding system comprising:
a laser bank having one or more laser channels, each laser channel outputting a laser light from a laser light source to a laser delivery bundle which delivers the laser light to a plurality of work pieces via a waveguide, wherein the laser delivery bundle has at least a laser delivery optical fiber;
a dopant positioned at a location downstream of the delivery end of the laser delivery optical fiber for upconverting laser light back through the laser delivery optical fiber; and
a sensor positioned within the laser channel for sensing upconverted laser light from the dopant and for outputting a signal indicative of an intensity of the sensed upconverted laser light to a controller, wherein the controller is configured to determine intensity of laser light delivered by the laser delivery bundle based on the intensity of the sensed upconverted laser light.

10. The simultaneous laser welding system of claim 9, wherein the laser delivery optical fiber has a dopant comprising a dopant end positioned at a location downstream of the delivery end of the laser delivery optical fiber.

11. The simultaneous laser welding system of claim 9, wherein the dopant comprises a dopant end positioned on a delivery end of a laser delivery optical fiber.

12. The simultaneous laser welding system of claim 9, wherein the dopant comprises a dummy part infused with the dopant and is positioned where a plurality of work pieces would reside during a weld cycle.

13. The simultaneous laser welding system of claim 9, wherein the dopant comprises a paint or lacquer applied to a surface of one of the work pieces.

14. The simultaneous laser welding system of claim 9, wherein the controller is configured to alert a user when the controller determines that the intensity of laser light delivered by the laser delivery optical fiber is unsatisfactory.

15. The simultaneous laser welding system of claim 9, wherein the controller is configured to adjust the laser light intensity when the controller determines that the intensity of laser light delivered by the laser delivery optical fiber is unsatisfact
